(19) United States
(12) Patent Application Publication
(10) Pub. No.: US 2013/0054792 A1
(43) Pub. Date: Feb. 28, 2013

(54) CLOUD-BASED PERFORMANCE TESTING OF FUNCTIONALITY OF AN APPLICATION PRIOR TO COMPLETION OF DEVELOPMENT

(71) Applicant: Samuel Sharaf, San Francisco, CA (US)

(72) Inventor: Samuel Sharaf, San Francisco, CA (US)

(73) Assignee: SALESFORCE.COM, INC., San Francisco, CA (US)

(21) Appl. No.: 13/349,176

(22) Filed: Jan. 12, 2012

Related U.S. Application Data
(60) Provisional application No. 61/527,315, filed on Aug. 25, 2011.

(51) Int. Cl. G06F 15/173

(52) U.S. Cl. 709/224

(57) ABSTRACT

Provided here is a computer-implemented method of performance testing functionality of a cloud-based application during development of the cloud-based application. The method obtains a defined use case from a plurality of use cases to be supported by the cloud-based application, and executed an automated performance test on the defined use case prior to completion of development of the cloud-based application. The method continues by generating an output that summarizes the performance test results. The steps of obtaining, executing, and generating can be repeated for a plurality of additional defined use cases as needed.

### CROSS-REFERENCE TO RELATED APPLICATION(S)

This application claims the benefit of U.S. provisional patent application Ser. No. 61/527,315, filed Aug. 25, 2011.

### TECHNICAL FIELD

Embodiments of the subject matter described herein relate generally to computer systems and computer-implemented applications. More particularly, embodiments of the subject matter relate to performance testing methodologies suitable for use with a cloud-based application.

### BACKGROUND

Modern software development is evolving away from the client-server model toward network-based processing systems that provide access to data and services via the Internet or other networks. In contrast to traditional systems that host networked applications on dedicated server hardware, a cloud computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Most cloud-based applications are implemented for use with Internet browsers running on client devices. Consequently, such web-based applications are susceptible to response time delays, loading effects, and other factors that might impact the end user experience. For this reason, cloud-based applications can be subjected to performance testing to determine response times under various simulated loading conditions and to check whether stated service level agreement requirements are satisfied. Performance testing of applications is traditionally performed at the end of the development cycle, after functional testing has been completed. In this regard, performance testing is performed at a macro level to analyze the overall performance of the entire product.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an exemplary embodiment of a cloud-based performance testing system;

FIG. 2 is a schematic representation of an exemplary multi-tenant data processing system;

FIG. 3 is a flow chart that illustrates an exemplary embodiment of a performance testing process;

FIG. 4 is a flow chart that illustrates another exemplary embodiment of a performance testing process;

FIG. 5 is an illustration of an exemplary graphical user interface (GUI) rendered in connection with a performance testing process;

FIG. 6 is an illustration of an exemplary recording procedure carried out for a designated use case; and

FIG. 7 is an illustration of another exemplary GUI rendered in connection with a performance testing process.

### DETAILED DESCRIPTION

The subject matter presented here relates to a performance testing methodology suitable for use during the development of a cloud-based application. The performance testing approach described here checks individual use cases and/or work flows of the intended cloud-based application. In this regard, individual functions and features of the application can be performance tested in an ongoing manner during the development of the application (rather than waiting until the end of the development cycle). In certain exemplary embodiments, use cases are performance tested with the aid of a web portal and a cloud-based performance testing architecture. The web portal is designed to be user-friendly from the perspective of application developers, such that the results of the performance testing can be quickly and easily understood, interpreted, and utilized by developers without needing the assistance of experts or performance engineers.

Cloud-based performance analysis refers to a product which offers performance analysis as a service to product developers/engineers during the product development lifecycle. An embodiment of the concept presented here integrates performance analysis into the product development lifecycle and offers performance analysis in an easy to use web user interface that enables individual product developers to analyze performance for their development use cases without requiring the installation of any software at the client device.

Performance analysis of a software product during the product development lifecycle if often merely an afterthought. Indeed, the focus is usually on meeting the functional requirements and rolling out the product to the market as soon as possible. This often leads to products which do not meet the general performance criteria. It is a well known fact that websites start losing customers if the response time on page loading exceeds about three seconds. In turn, lost customers typically result in lost revenue.

Companies with good robust products provide for sufficient time for performance analysis after the product design and development lifecycle is complete. Although this approach is certainly better than not doing performance analysis at all (or doing performance analysis after scalability issues arise), it still leads to problems if there is a major performance issue identified during the last phase of the product release cycle.

Although performance analysis has historically been applied to completed software products, there are not any cloud based products which offer performance analysis during the product development lifecycle without requiring the installation of client software. Accordingly, the exemplary embodiments described below focus on providing an easy to use web interface that allows individual product developers to test their use cases without having to consult or hire performance analysis experts.

In accordance with one exemplary embodiment, a cloud-based performance analysis architecture includes at least the following components installed in a network environment: (1) an intuitive web user interface; (2) a performance analysis tool, such as THE GRINDER open source load testing framework; (3) a reporting tool, such as THE GRINDER ANALYZER open source application; and (4) one or more other tools to analyze web pages and generate reports. The web interface represents a user-friendly portal that allows a user to: configure load testing parameters (e.g., define proxy, port number, number of concurrent users, and duration of test); perform recording of functional use cases (e.g., go through the flow of shopping for an item and adding to cart); generate reports; and analyze results and recommendations. In practice, the web interface will be simple and very easy to use with little to no training The engine behind the performance web interface may include existing products, applications, and technologies including, without limitation: THE GRINDER framework; THE GRINDER ANALYZER product; the YSLOW web page analyzer; and the FIREBUG web development tool.

The GUI can be provided in connection with a client web browser application. In certain exemplary embodiments the GUI provides the following capabilities, without limitation: (1) a portal to configure TCP proxy settings such as port number and (for SSL) any needed certificates to be imported; (2) a simple text input to accept the URL of the page which acts as a starting point for the use case; (3) a button to start recording the user interaction with the website; (4) a simple portal to configure load testing parameters, e.g., number of concurrent users and duration of time; and (5) a button to generate charts/graphs to display performance results and recommendations. As one example, the GUI may provide a text input field that allows the user to enter the URL for an initial web page associated with the use case under test.

In accordance with one exemplary deployment architecture, THE GRINDER load runner and THE GRINDER ANALYZER products are hosted in a cloud-based environment which serves as the engine behind the web user interface. The complexity of THE GRINDER and THE GRINDER ANALYZER tools can be abstracted from the end user by the intuitive user interface. In fact, the end user need not have access to or have any knowledge of the particular tools and applications that are utilized to provide the performance analysis functionality.

From an infrastructure perspective, the system can be an N-Tier architecture that utilizes MySQL database technology to store the performance results for a particular use case. THE GRINDER tool uses an agent/controller architecture. However, as stated previously, the complexity of THE GRINDER can be hidden from the user and the solution can be designed in such a way that an end user configures a minimal set of parameters to test the designated scenario or use case. In practice, the agents utilized by THE GRINDER inject the load into the system under test and the results and logs are reported and maintained on the controller server.

Once the user has finished recording the use case and running the performance test, e.g., with ten concurrent users for thirty minutes, the user can click on the analyze button. Upon clicking the analyze button the system will generate reports and graphs for the user based on the performance test data generated by the agents. Any number of reports, graphs, statistical charts, and other output formats could be generated by an embodiment of the performance analysis system. Moreover, tested use cases and web pages can be graded using a common scale that is based on tested performance criteria, such as response time. In practice, the cloud-based performance analysis tool can also generate (optionally) grades on web page components based on industry standard web performance rules.

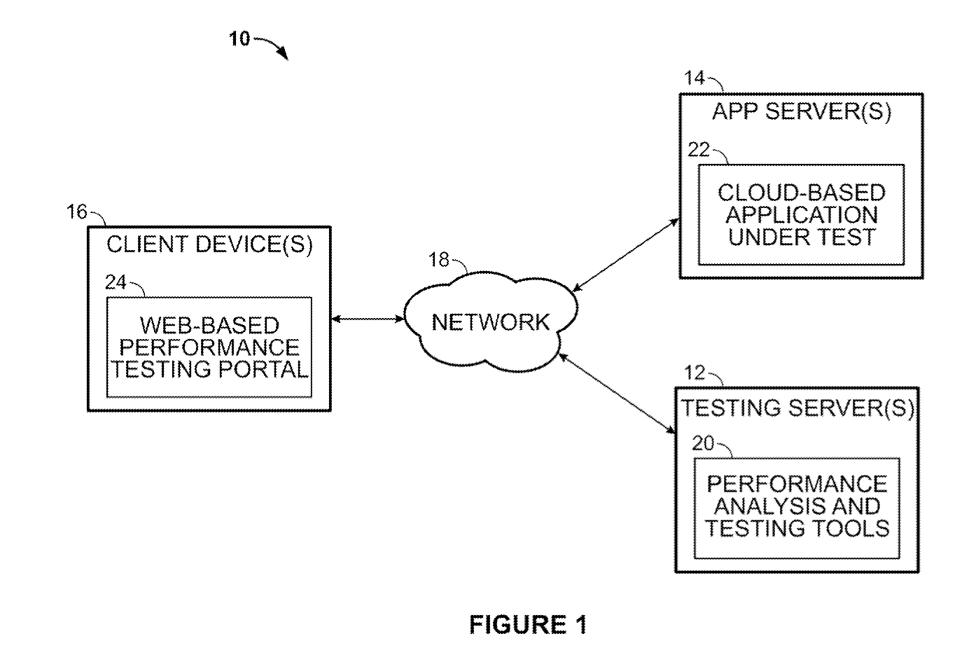

Referring now to the drawings, FIG. 1 is a schematic representation of an exemplary embodiment of a cloud-based performance testing system 10 that is suitably configured to support the testing of cloud-based applications under development. The system 10 can be realized as a computer-implemented system that is deployed using general purpose computer hardware and architectures. The illustrated embodiment of the system 10 includes, without limitation: one or more testing servers 12; one or more application servers 14; and one or more client devices 16. These primary components of the system 10 are operatively coupled together via a network 18, which may include or cooperate with the Internet, a cellular service network, a local area network (LAN), a wireless network, a satellite communication network, any combination thereof, or the like. FIG. 1 depicts a simplified representation of the system 10 for clarity and ease of description. It should be appreciated that a practical implementation of the system 10 may include additional components, features, and elements.

Although any number of testing servers 12 may be deployed throughout the system 10, the following description assumes that only one testing server 12 is deployed. The testing server 12 includes or cooperates with one or more suitably configured performance analysis and testing tools 20. The performance analysis and testing tools 20 can execute automated performance tests on certain user-defined or user-designated use cases, work flows, web pages, or the like, in response to instructions received from the client devices 16. In certain embodiments, the performance analysis and testing tools 20 carry out load testing, obtain test results, generate a suitable output (such as a report) that includes the test results, analyze the test results, make recommendations to the application developers, etc. The test results may be provided to the client devices 16 in any human-readable format, such as a graph of response time versus elapsed time, a chart that indicates the number of http requests associated with the tested use case, a grade or score assigned to the tested use case, or the like. In addition to load testing, the performance analysis and testing tools 20 may provide, without limitation: (1) a detailed view of the response times for individual components within a web application; (2) a grade-based view of the individual components of a web application, e.g., grades of “A” to “F”, where grade “A” represents a web component confirming best practices and grade “F” represents a web component implemented in a way not adhering to best practices; and (3) a graphical view with the ability to break down overall response time into individual sections and drill down into individual application components to identify where the performance bottleneck lies.

As mentioned above, certain exemplary embodiments of the system 10 leverage open source performance analysis tools, such as THE GRINDER framework. It should be appreciated that alternative or additional tools, technologies, and methodologies could be incorporated into the performance analysis and testing tools 20. In this regard, the testing server 12 may include or cooperate with one or more of the following available products, without limitation: (1) the JIFFY web page instrumentation and measurement suite; (2) the open source Visualization API Engine, which operates on collected data from a web application to generate graphical views; or (3) a custom user interface written in HTML5, CS S3, and JavaScript to enable users to interact with the self-service cloud based solution.

Although any number of application servers 14 may be deployed throughout the system 10, the following description assumes that only one application server 14 is deployed. The application server 14 may communicate and cooperate with the testing server 12 directly or via the network 18. In certain implementations, the application server 14 and the testing server 12 are provided by and maintained by the same entity, business, service provider, or the like. Indeed, the application server 14 and the testing server 12 could be co-located at the same facility. Alternatively, the application server 14 and the testing server 12 could be realized together in an integrated manner in a single piece of hardware if so desired.

The application server 14 is suitably configured to host at least one cloud-based application under test 22. The application under test 22 is intended to support a plurality of different use cases, work flows, features, and functions (even though during the development cycle the functionality of the application under test 22 will be limited, restricted, or otherwise incomplete). Notably, the system 10 is capable of running performance tests at a “micro” level, i.e., individual use cases, work flows, usage scenarios, functions, and/or features can be tested whenever the associated functionality has been implemented. Thus, performance testing can be initiated during the development cycle of the cloud-based application, well in advance of the overall completion date. Accordingly, any performance issues related to individual use cases or work flows can be detected early in the development phase, which allows the product developers to address those issues (if needed) in an ongoing manner rather than waiting until the entire product has been fully developed. In this regard, the cloud-based application under test 22 represents an “incomplete” or not fully developed application that has at least some functionality that is ready for performance testing.

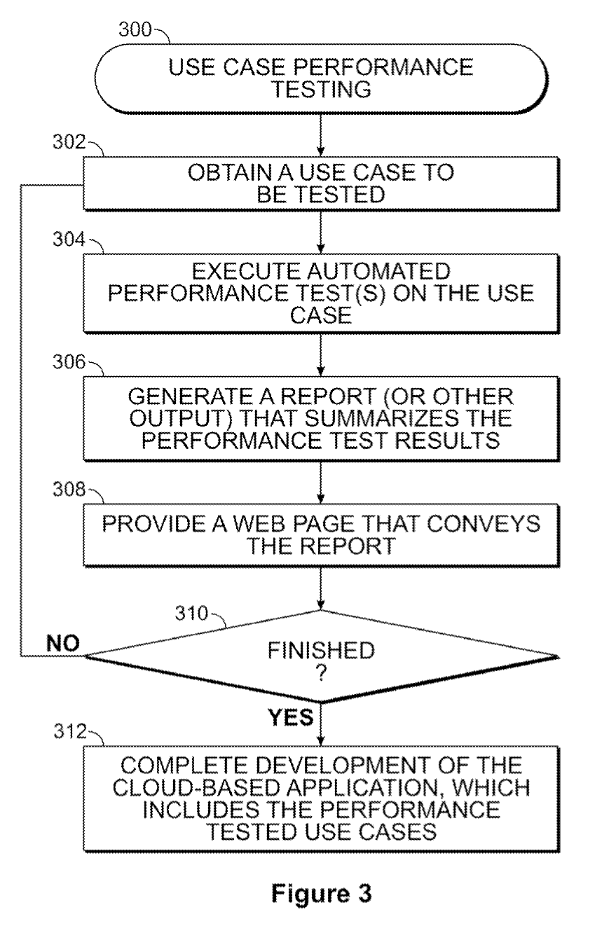

Although the system 10 can support a plurality of different client devices 16, this example assumes that only one client device 16 is being used. The client device 16 can be realized as any computer-based device, e.g., a desktop computer, a portable computer, or a smartphone device. The client device 16 communicates with the testing server 12 via the network 18, using well known network communication techniques, technologies, and protocols. In certain embodiments, the client device 16 can also communicate with the application server 14 via the network 18. As described in more detail below, the client device 16 includes or cooperates with a web browser application that facilitates the presentation of a web-based performance testing portal 24 at a display element of the client device 16. The portal 24 is rendered with various GUI elements that accommodate user interaction with the testing server 12 for purposes of executing performance testing on defined use cases (which are to be supported by the cloud-based application under test 22). Thus, the portal 24 enables a user of the client device 16 to access and utilize the cloud-based performance analysis and testing tools 20 during the development phase of the cloud-based application under test 22. Certain exemplary features of the portal 24, along with various processes related to performance testing of individual use cases, are described in more detail below with reference to FIGS. 3-7.

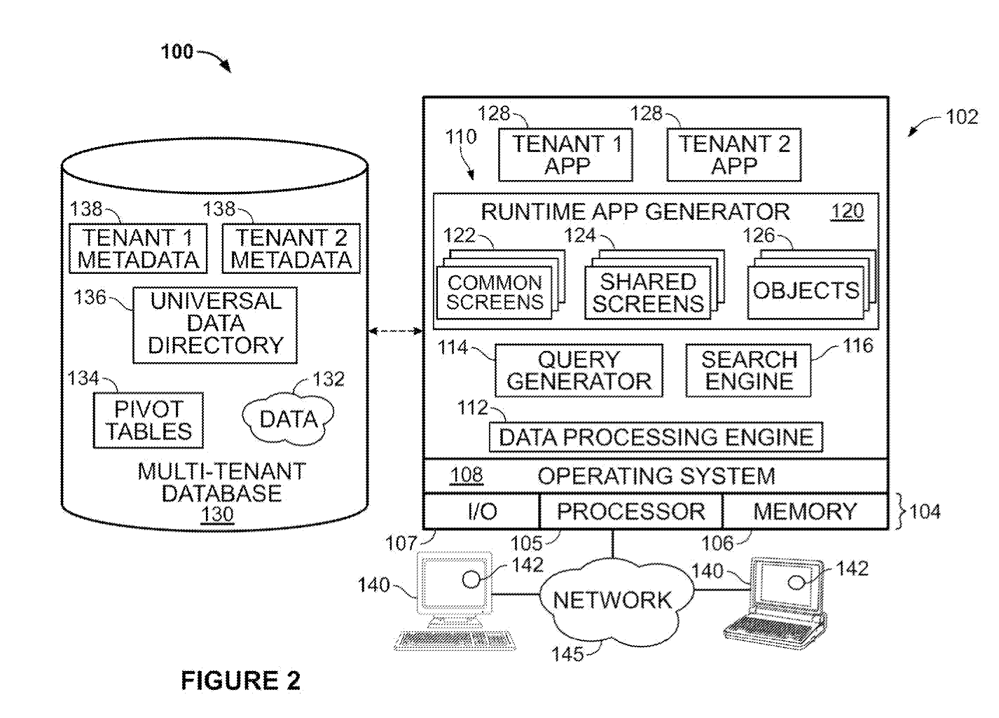

As mentioned above, the testing servers 12 and the application servers 14 may be implemented in connection with a cloud-based architecture that supports a plurality of remote client devices 16. In certain embodiments, the application servers 14 may be utilized with a multi-tenant architecture to support a plurality of different tenants, each having multiple users. In such embodiments, therefore, the cloud-based application under test 22 may be intended to be hosted by the application servers 14 for use by at least one of the plurality of different tenants. In this regard, FIG. 2 is a schematic representation of an exemplary multi-tenant application system 100, which could be utilized in the context of the cloud-based performance testing system 10.

Turning now to FIG. 2, an exemplary multi-tenant application system 100 suitably includes a server 102 that dynamically creates virtual applications 128 based upon data 132 from a common database 130 that is shared between multiple tenants. Data and services generated by the virtual applications 128 are provided via a network 145 to any number of user devices 140, as desired. Each virtual application 128 is suitably generated at run-time using a common application platform 110 that securely provides access to the data 132 in the database 130 for each of the various tenants subscribing to the system 100. The server 102 could represent one exemplary embodiment of the application server 14 illustrated in FIG. 1. In accordance with one non-limiting example, the system 100 may be implemented in the form of a multi-tenant customer relationship management system that can support any number of authenticated users of multiple tenants.

A “tenant” or an “organization” generally refers to a group of users that shares access to common data within the database 130. Tenants may represent customers, customer departments, business or legal organizations, and/or any other entities that maintain data for particular sets of users within the system 100. Although multiple tenants may share access to the server 102 and the database 130, the particular data and services provided from the server 102 to each tenant can be securely isolated from those provided to other tenants. The multi-tenant architecture therefore allows different sets of users to share functionality without necessarily sharing any of the data 132.

The database 130 is any sort of repository or other data storage system capable of storing and managing the data 132 associated with any number of tenants. The database 130 may be implemented using any type of conventional database server hardware. In various embodiments, the database 130 shares processing hardware 104 with the server 102. In other embodiments, the database 130 is implemented using separate physical and/or virtual database server hardware that communicates with the server 102 to perform the various functions described herein.

The data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired.

Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants. Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 is implemented using one or more actual and/or virtual computing systems that collectively provide the dynamic application platform 110 for generating the virtual applications 128. The server 102 operates with any sort of conventional processing hardware 104, such as a processor 105, memory 106, input/output features 107 and the like. The processor 105 may be implemented using one or more of microprocessors, microcontrollers, processing cores and/or other computing resources spread across any number of distributed or integrated systems, including any number of “cloud-based” or other virtual systems. The memory 106 represents any non-transitory short or long term storage capable of storing programming instructions for execution on the processor 105, including any sort of random access memory (RAM), read only memory (ROM), flash memory, magnetic or optical mass storage, and/or the like. The server 102 typically includes or cooperates with some type of computer-readable media, where a tangible computer-readable medium has computer-executable instructions stored thereon. The computer-executable instructions, when read and executed by the server 102, cause the server 102 to perform certain tasks, operations, functions, and processes described in more detail herein. In this regard, the memory 106 may represent one suitable implementation of such computer-readable media. Alternatively or additionally, the server 102 could receive and cooperate with computer-readable media (not separately shown) that is realized as a portable or mobile component or platform, e.g., a portable hard drive, a USB flash drive, an optical disc, or the like. Referring to FIG. 1, it should be appreciated that the general hardware and functional configuration of the application server 14 and the testing server 12 may be similar to that described here for the server 102. In this regard, the testing server 12 may be realized as a computer-implemented system having a processor and memory, where the memory stores computer-executable instructions that, when executed by the processor, cause the testing server 12 to perform various processes, methods, and techniques related to performance analysis of individual use cases and work flows (as described in more detail herein).

The input/output features 107 represent conventional interfaces to networks (e.g., to the network 145, or any other local area, wide area or other network), mass storage, display devices, data entry devices and/or the like. In a typical embodiment, the application platform 110 gains access to processing resources, communications interfaces and other features of the processing hardware 104 using any sort of conventional or proprietary operating system 108. As noted above, the server 102 may be implemented using a cluster of actual and/or virtual servers operating in conjunction with each other, typically in association with conventional network communications, cluster management, load balancing and other features as appropriate.

The application platform 110 is any sort of software application or other data processing engine that generates the virtual applications 128 that provide data and/or services to the user devices 140. Referring again to FIG. 1, upon completion and release, the cloud-based application under test 22 may be considered to be one of the virtual applications provided by the server 102. The virtual applications 128 are typically generated at run-time in response to queries received from the user devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the user devices 140. The virtual applications 128 created by tenants are typically constructed in accordance with the tenant-specific metadata 138, which describes the particular tables, reports, interfaces and/or other features of the particular application. In various embodiments, each virtual application 128 generates dynamic web content that can be served to a browser or other client program 142 associated with its user device 140, as appropriate.

The runtime application generator 120 suitably interacts with the query generator 114 to efficiently obtain multi-tenant data 132 from the database 130 as needed. In a typical embodiment, the query generator 114 considers the identity of the user requesting a particular function, and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user that initiated the request.

The data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In operation, developers use the application platform 110 to create data-driven virtual applications 128 for the tenants that they support. Such virtual applications 128 may make use of interface features such as tenant-specific screens 124, universal screens 122 or the like. Any number of tenant-specific and/or universal objects 126 may also be available for integration into tenant-developed virtual applications 128. The data 132 associated with each virtual application 128 is provided to the database 130, as appropriate, and stored until it is requested or is otherwise needed, along with the metadata 138 that describes the particular features (e.g., reports, tables, functions, etc.) of that particular tenant-specific virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith. In an exemplary embodiment, each object type includes one or more fields for indicating the relationship of a respective object of that object type to one or more objects of a different object type (e.g., master-detail, lookup relationships, or the like).

Still referring to FIG. 2, the data and services provided by the server 102 can be retrieved using any sort of personal computer, mobile telephone, portable device, tablet computer, or other network-enabled user device 140 that communicates via the network 145. Typically, the user operates a conventional browser or other client program 142 to contact the server 102 via the network 145 using, for example, the hypertext transport protocol (HTTP) or the like. The user typically authenticates his or her identity to the server 102 to obtain a session identifier (“SessionlD”) that identifies the user in subsequent communications with the server 102. When the identified user requests access to a virtual application 128, the runtime application generator 120 suitably creates the application at run time based upon the metadata 138, as appropriate. The query generator 114 suitably obtains the requested data 132 from the database 130 as needed to populate the tables, reports or other features of the particular virtual application 128. As noted above, the virtual application 128 may contain Java, ActiveX, or other content that can be presented using conventional client software running on the user device 140; other embodiments may simply provide dynamic web or other content that can be presented and viewed by the user, as desired.

A computer-based system, such as the system 10 described above, can be configured to accommodate performance testing and analysis of individual use cases, discrete work flows, and functions to be supported by a cloud-based application that is still undergoing development. In this regard, FIG. 3 is a flow chart that illustrates an exemplary embodiment of a performance testing process 300, which might be performed by the system 10. The various tasks performed in connection with a process described herein may be performed by software, hardware, firmware, or any combination thereof For illustrative purposes, a description of a process may refer to elements mentioned above in connection with FIG. 1 and FIG. 2. In practice, portions of a described process may be performed by different elements of the described system, e.g., a testing server, a performance analysis tool, a client device, an application server, or the like. It should be appreciated that an embodiment of an illustrated process may include any number of additional or alternative tasks, the tasks shown in a given figure need not be performed in the illustrated order, and a described process may be incorporated into a more comprehensive procedure or process having additional functionality not described in detail herein. Moreover, one or more of the tasks shown in a given figure could be omitted from an embodiment of the described process as long as the intended overall functionality remains intact.

The process 300 represents one embodiment of a computer-implemented method of performance testing the functionality of a cloud-based application during development of the application. The exemplary embodiment of the process 300 begins by obtaining a defined or otherwise designated use case or work flow to be tested (task 302). This use case will be one of a plurality of different use cases that will ultimately be supported by the cloud-based application that is currently under development. As used here, a “use case” refers to a set of discrete actions, which can be performed by an end user of the application to achieve certain outcomes/results. For example, a typical use case can refer to a scenario where a user logs in to a web application to book travel itinerary. A “work flow” is closely associated with a use case. However, a work flow for a typical use case may be defined/governed by certain business rules. In this regard, in the above example of a use case being used to book travel, the associated work flow may require behind the scenes approval by certain actors within the overall work flow. For ease of description, the term “use case” is used in a general sense that also includes work flows. In practice, a cloud-based application may support many individual use cases, and a particular use case may be relatively simple and straightforward or it may be relatively complex and involved. A use case will typically be associated with at least some user interaction, and will typically require the rendering and display of multiple web pages. For example, one defined use case may be associated with a login procedure that requires the user to enter his or her user credentials for authentication. As another example, a use case may be associated with the processing of a user-entered search query and the display of one or more search results pages. As yet another example, a use case may be associated with the creation and saving of an entry in an address book or contacts list.

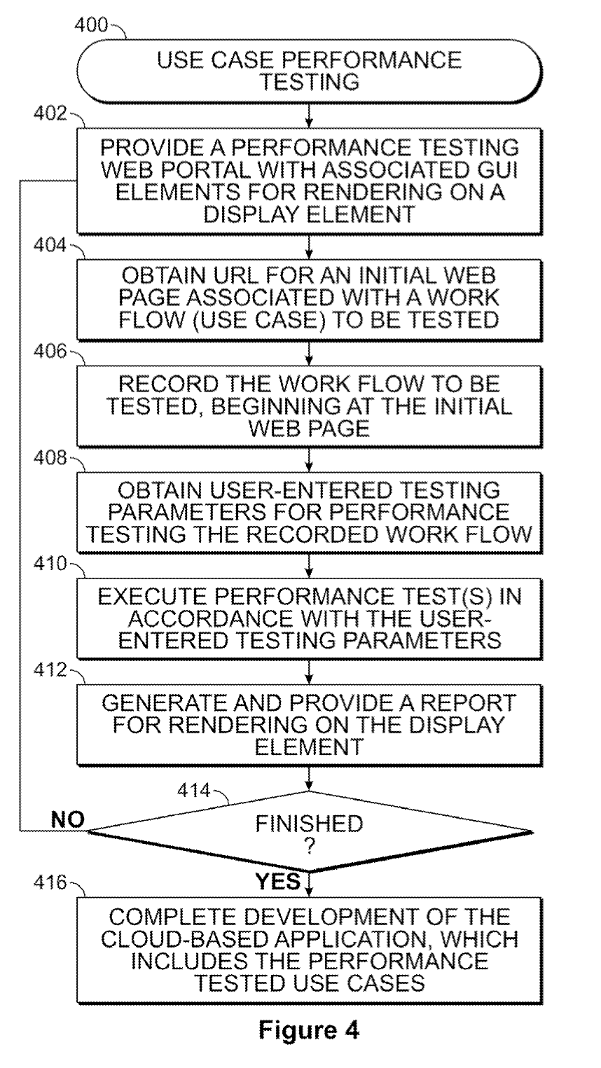

A use case, function, work flow, or feature to be tested can be obtained in any appropriate manner. As explained in more detail below with reference to FIG. 4, task 302 may be associated with a user-initiated recording of a simulation of the defined use case. As another example, a use case could be obtained during task 302 by using a built-in TCP proxy, which routes the web requests and records user interactions with the web application. Other than using a TCP proxy for recording, a web user might use other means (e.g., a network based sniffer) to record user interaction with the web application and submit it to the cloud-based self-service performance portal for analysis. In the latter case, it may be necessary to confirm that the use case adheres to certain system requirements. These system requirements may be as follows: (1) the use case must have the required HTTP Headers for all the HTTP or HTTPS requests made by the user; and (2) the use case must have the IP packets containing the required information associated with the HTTP requests.

After obtaining the use case to be tested, the process 300 continues by executing at least one automated performance test on the use case (task 304). Notably, this performance test is executed prior to completion of the development of the cloud-based application. As described in more detail below with reference to FIG. 4, the performance analysis and testing may be executed in accordance with certain user-entered testing parameters, settings, and/or configuration data. Although a number of different performance tests could be run, the exemplary embodiment executes automated load testing on the defined use case to obtain response time measurements for the use case. Upon completion of the performance test(s), the process generates a report or other suitable output that summarizes the performance test results (task 306). In certain implementations, task 306 simplifies, condenses, or filters the performance test results into a format that is easy to read, interpret, and understand. The report can be provided as a hypertext markup language document (e.g., a web page) for rendering at the client device (task 308).

In practice, the output may be generated in a way that is intended for use by application developers rather than exclusively by performance engineers or other experts in the field of performance analysis. For example, the report may include certain performance metrics for the defined use case, such as response times, number of http requests, etc. The system could also be configured to provide some or all of the following actionable data to the users, without limitation: (1) overall performance analysis of the web application using both graphical and tabular layouts; (2) a graphical interface providing drill down ability to identify particular bottlenecks within the web application; (3) a grade-based analysis of the individual components within the web application using standard web practices. Regarding item (3) above, the individual web components are not only analyzed with respect to loading time/response time, but also analyzed with respect to their compliance to certain web standards and best practices. For example, if a particular use case within the web application incorporates a substantial amount of inline CSS and JavaScript, the system might provide a grade of “F” to the user interface implementation of the web application.

Testing of individual use cases may proceed in the manner described above for a plurality of additional defined use cases. In practice, performance testing can be repeated in this manner for all possible use cases of the cloud-based application. Accordingly, if the process 300 is finished (the “Yes” branch of query task 310), then the development of the cloud-based application can be completed (task 312). Notably, the application will include the performance tested use cases, which are preferably tested in an ongoing manner during the development of the application. Thus, when the last use case is analyzed and satisfies the performance specifications, the application developers can be extremely confident that the overall cloud-based application will satisfy all performance specifications. If more use cases remain to be tested and/or developed (the “No” branch of query task 310), then the process 300 returns to task 302 at an appropriate time to accommodate testing of another use case.

In certain preferred embodiments, an application developer can analyze individual use cases with the assistance of a web-based performance analysis portal, which can be rendered for display on a client device such as a desktop computer, a laptop computer, or a mobile device. In practice, the web portal can be presented using any suitable web browser application, and the web portal may include any number of GUI elements, pages, screens, and graphical features that provide the stated functionality and user-friendly features described here. FIGS. 4-7 relate to an example where such a web portal is utilized to carry out performance analysis on one or more use cases or work flows.

FIG. 4 is a flow chart that illustrates another exemplary embodiment of a performance testing process 400. It should be appreciated that certain aspects of the process 400 are similar or identical to that described above for the process 300. For the sake of brevity, common or shared aspects will not be redundantly described in the context of the process 400. The process 400 begins by providing a performance testing web portal for rendering on a display element (task 402). The web portal includes or is otherwise associated with one or more web pages, screens, or GUI elements that accommodate user entries, user commands, and the like.

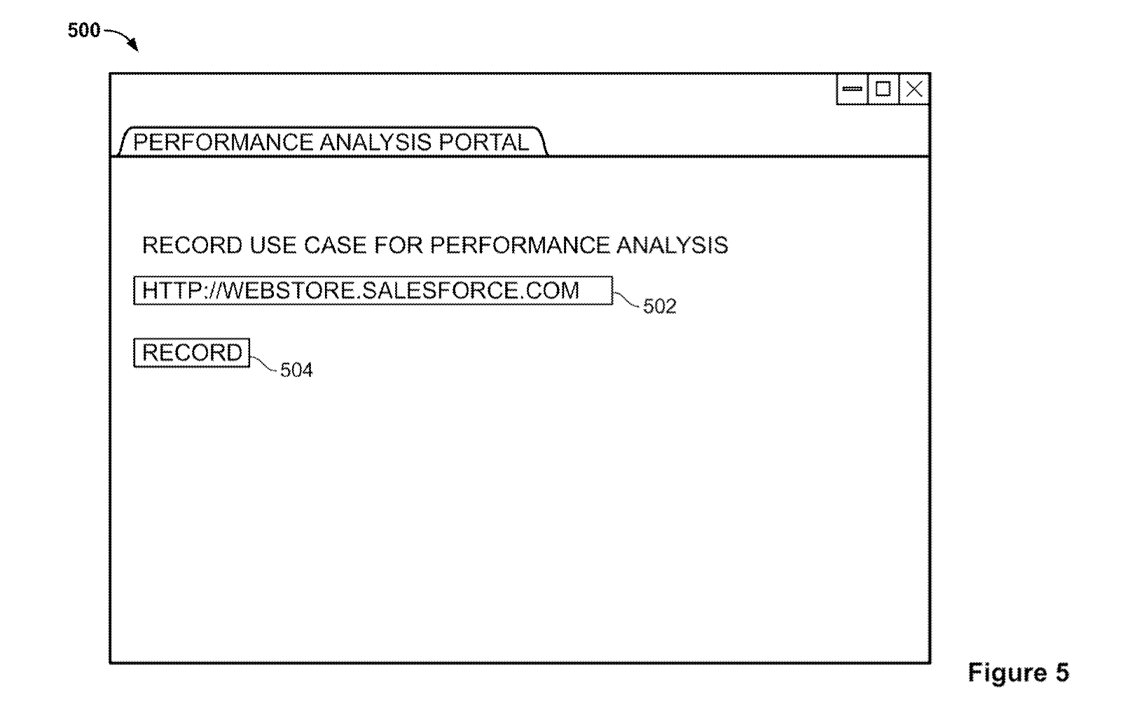

This example assumes that a user interacts with the web portal to initiate a performance test for a single use case during the development phase of a cloud-based application that is intended to support the tested use case and a plurality of additional use cases (after development is complete and the application is ready for release). In practice, the web portal may provide an active link or control element (not shown) that allows the user to initiate the performance analysis. For this example, the web portal provides a GUI element or web page that is designed, arranged, and formatted to record a use case for performance testing. In this regard, FIG. 5 is an illustration of an exemplary GUI 500 that accommodates the recording of a use case. As mentioned above, the GUI 500 can be provided as a suitably formatted HTML document. The GUI 500 includes a field 502 that accommodates entry of a uniform resource locator (URL) that corresponds to an initial web page for the recorded use case. In practice, the user populates the field 502 with the desired URL, which represents the starting point of the use case to be tested. The GUI 500 also includes a “Record” button 504 that, when activated, initiates a use case recording process by providing the entered URL to the testing server.

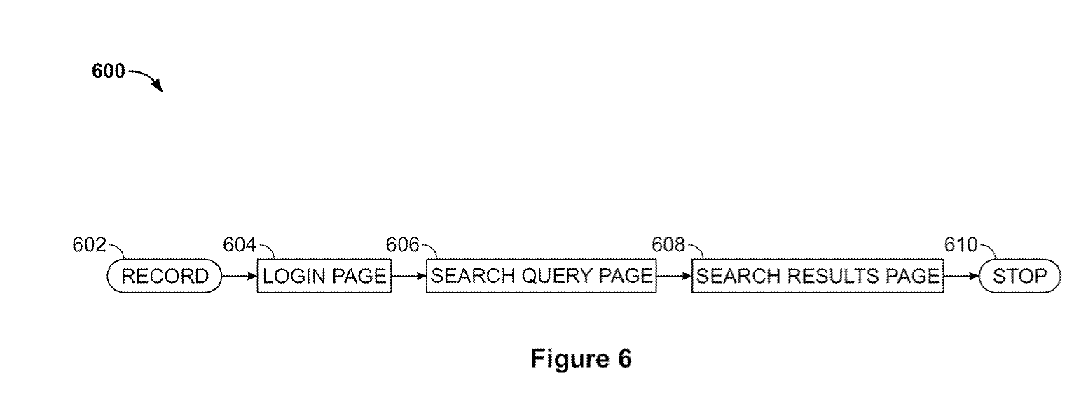

Referring back to FIG. 4, the process 400 obtains the URL for the initial web page associated with the use case to be tested (task 404) and proceeds to record the use case, beginning at the initial web page (task 406). In practice, therefore, the process 400 may need to cooperate with an application server to access the portion of the cloud-based application that is responsible for executing the use case under test. It should be appreciated that a use case under test may involve only one web page, i.e., the initial web page, or it may involve any number of different web pages that are provided in response to the functionality of the use case, user interaction, or the like. Recording of the use case under test may be achieved using the web portal as a tool to capture the user work flow, steps, and web pages generated for the use case. In this regard, FIG. 6 is an illustration of an exemplary recording procedure 600 carried out for a designated use case. FIG. 6 depicts one non-limiting example of a use case that involves a login procedure and, thereafter, a search procedure. The recording procedure 600 begins with a “Record” command 602 that designates the initial URL for the use case. This example assumes that the initial URL points to a user login page 604. The login page 604 allows the user to enter his or her credentials for purposes of authentication. During the recording procedure 600, the user will enter the data needed for authentication to emulate the work flow.

This example assumes that the user is successfully authenticated, and that the defined use case generates a search query page 606 following successful authentication. This response and the transition to the search query page 606 is recorded. The search query page 606 allows the user to enter a search query. During the recording procedure 600, the user enters a mock search query that is suitable for testing purposes. This example assumes that the use case under test processes the search query and generates a corresponding search results page 608. This response and the transition to the search results page 608 is recorded. This example assumes that the search results page 608 represents the end of the use case. In practice, the recording procedure 600 can be terminated with a “Stop” command 610, which may be issued in response to user interaction with the web portal. In response to the “Stop” command 610, the recording procedure 600 saves a recorded simulation of the defined use case in an appropriate manner for purposes of testing.

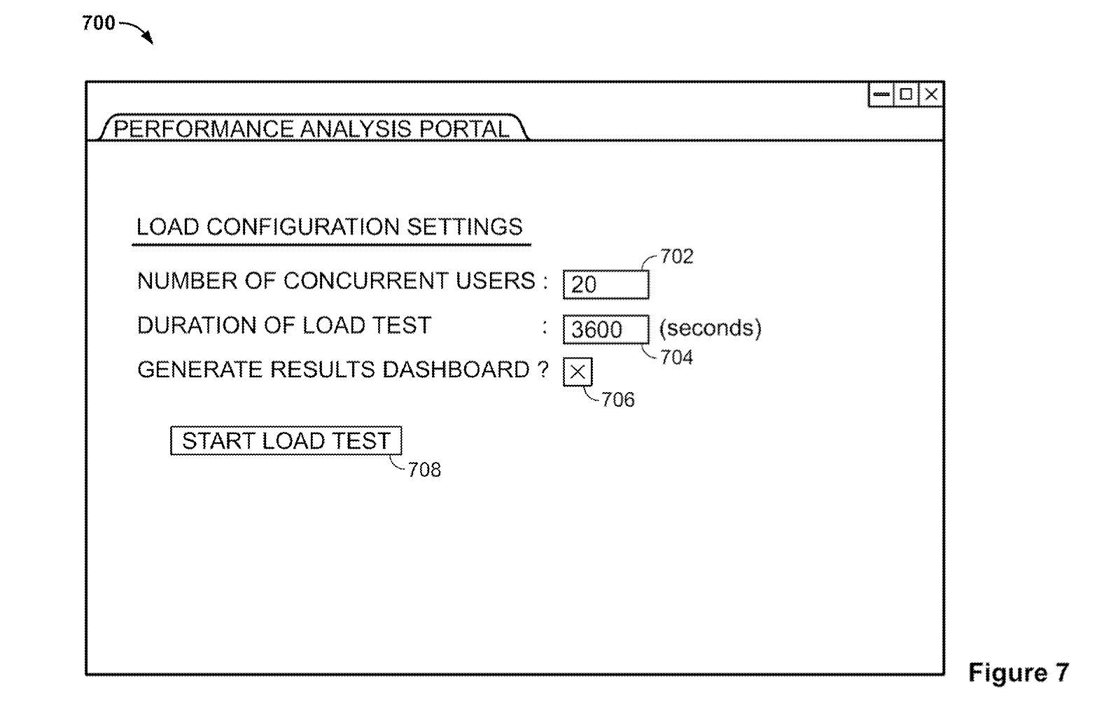

Referring back to FIG. 4, after successfully recording the simulated use case, the process 400 continues by obtaining user-entered performance testing parameters, settings, configuration data, and/or commands to be applied when performance testing the recorded use case (task 408). The web portal may be used as a tool to obtain the testing parameters from the user. In this regard, FIG. 7 is an illustration of another exemplary GUI 700 that accommodates the collection of testing criteria. As mentioned above, the GUI 700 can be provided as a suitably formatted HTML document. The GUI 700 includes a field 702 that accommodates entry of a number of concurrent users to be simulated during the performance testing. The field 702 enables the user to specify the loading conditions to be simulated during the performance analysis. The illustrated embodiment of the GUI 700 also includes a field 704 that accommodates entry of a duration for the performance testing. The GUI 700 also includes a checkbox element 706 that allows the user to select whether or not the test results are generated on a dashboard (or other GUI element) of the web portal. Although not shown in FIG. 7, the GUI 700 may include any number of alternative or additional fields, dropdown menus, checkboxes, or the like, for purposes of obtaining additional user-defined testing parameters to be applied to the recorded use case. After the desired testing parameters have been designated, the user may activate a “Start Load Test” button 708 to initiate the performance test. In practice, activation of the “Start Load Test” button 708 results in the transmission of the testing parameters to the testing server, which receives the testing parameters and thereafter applies the testing parameters to the recorded use case.

Referring again to FIG. 4, the process 410 executes the performance test (or tests) on the recorded use case, in accordance with the user-entered testing parameters (task 410). As mentioned above, the automated cloud-based performance testing preferably includes load testing of the recorded use case, although additional and/or alternative testing may be performed. Upon completion of the performance testing, the testing server prepares a suitable output for presentation at the client device. In certain embodiments, the process 400 generates and provides a report that includes a summary of the performance test results (task 412). The report can be provided for rendering on a display element of the client device, sent to the user as a suitably formatted file, provided in the form of a web page displayed in connection with the web portal, or the like.

Testing of individual use cases may proceed in the manner described above for a plurality of additional defined use cases. In practice, performance testing can be repeated in this manner for all possible use cases of the cloud-based application. Accordingly, if the process 400 is finished (the “Yes” branch of query task 414), then the development of the cloud-based application can be completed (task 416). Otherwise, the remainder of the process 400 can be repeated for at least one more use case. Performance testing in this “piecemeal” manner is desirable to allow developers to detect and resolve performance issues early in the development cycle and in an ongoing manner as new use cases become functional, rather than having to wait until the end of functional development before performance testing the entire application as a whole.

As mentioned previously, the testing server may leverage existing open source performance analysis tools, software, and applications. Accordingly, the specific manner in which the performance testing is carried out, the types of performance tests carried out, the format and type of test results, and other particulars related to the performance analysis tools might vary from one embodiment to another, and in accordance with the specific design and configuration of the performance analysis tools utilized by the testing server. For example, the test results for a given use case may include data associated with one or more of the following response times: an overall “end-to-end” response time; the response time associated with a web interface; the response time associated with a middleware or application layer; and the response time associated with a database layer. Moreover, test results may be conveyed in any format, preferably a format that is easy to interpret and read by developers. For example, test results may be conveyed using plots or graphs, charts, spread sheets, statistical summaries, grades or scores (e.g., numerical scores or letter grades), or the like.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A computer-implemented method of performance testing functionality of a cloud-based application during development of the cloud-based application, the method comprising:
obtaining a defined use case from a plurality of use cases to be supported by the cloud-based application;
executing an automated performance test on the defined use case prior to completion of development of the cloud-based application, to obtain performance test results for the defined use case;
generating an output that summarizes the performance test results; and
repeating the obtaining, the executing, and the generating for a plurality of additional defined use cases.

2. The method of claim 1, wherein the repeating is performed for all possible use cases of the cloud-based application.

3. The method of claim 1, wherein generating the output comprises:
generating a report that includes performance metrics for the defined use case; and
providing a hypertext markup language document that conveys the report.

4. The method of claim 1, wherein executing the automated performance test comprises:
executing an automated load test on the defined use case to obtain response time measurements for the defined use case.

5. The method of claim 1, wherein obtaining the defined use case comprises:
recording a simulation of the defined use case.

6. The method of claim 5, wherein executing the automated performance test comprises:
applying user-specified testing parameters to the recorded simulation of the defined use case.

7. The method of claim 5, further comprising:
providing a graphical user interface that accommodates recording of the simulation of the defined use case.

8. The method of claim 5, wherein recording the simulation of the defined use case comprises:
recording a uniform resource locator corresponding to an initial web page for the defined use case.

9. The method of claim 1, further comprising:
receiving a number of concurrent users for the simulation of the defined use case; and
receiving a duration for the simulation of the defined use case;
wherein executing the automated performance test comprises applying the number of concurrent users and the duration to the recorded simulation of the defined use case.

10. A computer-implemented method of performance testing functionality of a cloud-based application during development of the cloud-based application, wherein the cloud-based application designed to support a plurality of different user work flows, and wherein the method comprises:
providing, for rendering on a display element of a client device, a first graphical user interface (GUI) element to record one of the plurality of different user work flows, resulting in a recorded work flow;
providing, for rendering on the display element, a second GUI element to obtain user-entered testing parameters for performance testing of the recorded work flow;
performance testing the recorded work flow in accordance with the user-entered testing parameters;
generating a report for the recorded work flow, the report including results of the performance testing; and
providing the report for rendering on the display element.

11. The method of claim 10, wherein providing the first GUI element, providing the second GUI element, performance testing the recorded work flow, generating the report, and providing the report are repeated for each of the plurality of different user work flows.

12. The method of claim 10, wherein the first GUI element, the second GUI element, and the report are provided as hypertext markup language documents.

13. The method of claim 10, wherein performance testing the recorded work flow comprises load testing the recorded work flow.

14. The method of claim 10, wherein the first GUI element comprises a field to accommodate entry of a uniform resource locator corresponding to an initial web page for the recorded work flow.

15. The method of claim 10, wherein the second GUI element comprises a field to accommodate entry of a number of concurrent users to be simulated during the performance testing.

16. The method of claim 10, wherein the second GUI element comprises a field to accommodate entry of a duration for the performance testing.

17. A computer system comprising a processor and a memory, wherein the memory comprises computer-executable instructions that, when executed by the processor, cause the computer system to:
provide a graphical user interface (GUI) for rendering on a display element of a remote client device, the GUI accommodating user designation of one of a plurality of use cases to be supported by a cloud-based application under development, and the GUI accommodating user-defined performance testing parameters;
obtain a designated use case and user-defined performance testing parameters from the GUI;
execute, in response to the designated use case and the user-defined performance testing parameters, an automated performance test to obtain performance test results for the designated use case; and
provide at least some of the performance test results for rendering on the display element.

18. The computer system of claim 17, wherein:
the computer system is configured as a multi-tenant architecture to support a plurality of different tenants; and
the cloud-based application is intended to be hosted by the computer system for at least one of the plurality of tenants.

19. The computer system of claim 17, wherein the GUI is provided as a web-based portal provided by the remote client device.

20. The computer system of claim 17, wherein the GUI accommodates recording of each of the plurality of use cases for individual performance testing of each of the plurality of use cases.
